(19) United States
(12) Patent Application Publication
(10) Pub. No.: US 2004/0125077 A1
(43) Pub. Date: Jul. 1, 2004

(54) Remote control for secure transactions

(76) Inventor: Jason A. Ashton, Scotts Valley, CA (US)

Correspondence Address: CARR & FERRELL LLP, 2200 GENG ROAD, PALO ALTO, CA, 94303, US

(21) Appl. No.: 10/661,149

(22) Filed: Sep. 12, 2003

Related U.S. Application Data
(63) Continuation-in-part of application No. 10/442,011, filed on May 19, 2003.
Application No. 10/442,011 is a continuation-in-part of application No. 10/264,617, filed on Oct. 3, 2002.

(51) Int. Cl. G09G 5/00

(52) U.S. Cl. 345/156

(57) ABSTRACT

A pointing device, such as a remote control, including a multi-bit data sensor configured to receive multi-bit data from a portable data repository. The multi-bit data sensor may include a transducer configured to read a bar code, characters, a magnetic strip or the like, and generate resulting electronic data. In various embodiments the portable data repository is a credit card, smart card or other data card. The pointing device may further include memory for data storage and a logic circuit for processing of stored data. In typical embodiments the remote control is configured to control a video display system.

### CROSS-REFERENCE TO RELATED APPLICATIONS

This application is a continuation-in-part of commonly owned U.S. patent application Ser. No. 10/442,011, entitled “Card Present Network Transactions,” filed May 19, 2003, and herein incorporated by reference. This application claims benefit of commonly owned U.S. patent application Ser. No. 10/264,617, entitled “Secure Input Device,” and filed Oct. 3, 2002. The disclosure of which is herein incorporated by reference.

### BACKGROUND

1. Field of the Invention

The invention is in the field of computer security and specifically in the field of secure data input and authentication.

2. Prior Art

Security and user authentication are significant areas of concern in computer technology. For example, these issues arise in relation to access restriction, network based transactions, and data privacy. In many applications simple security procedures such as entering a password or encryption key is considered insufficient because keystrokes entered from a keyboard are easily intercepted and passwords may be guessed. Passwords and other private data may then be used by unauthorized users.

For example, one area of concern includes cashless transactions which are a growing component of today's economy. These transactions typically involve entry of credit card information or user account information via a computer keyboard. When these transactions occur at a retail establishment a seller can easily take steps to determine the identity of a buyer and that the buyer is in actual possession of the credit card. This type of transaction is referred to as a “Card Present” transaction since the credit card must actually be present to proceed. In other transactions, such as those made over a telephone line or computer network, credit card information is provided verbally or by keyboard input. In these transactions it is more difficult to verify the identity of a buyer or if the buyer is in possession of the actual credit card.

In a typical cashless transaction, using a computer network, there are numerous points wherein credit card information may be improperly used or accessed. For example, keystrokes may be intercepted using monitoring software, the full credit card information is transmitted over a public computer network, and a seller receives and stores the full credit card information. This information may be accessed by an unauthorized employee of the seller or through a breach in the sellers computer security. Improperly obtained credit card information may be used by an unscrupulous buyer, even if the buyer is not in possession of the actual credit card because cashless transactions made from a personal computer are typically not card present transactions.

There is a need to improve the security of cashless transactions and user authentication over computer networks. These improvements would reduce fraud and other criminal activity. It is preferable to make these improvements without significantly increasing the complexity of a personal computer, the transaction itself, or the number of required peripheral devices.

### SUMMARY OF THE INVENTION

Embodiments of the invention include systems and methods of securely entering data into a computer and securely transferring the entered data over a computer network. These embodiments are optionally applied to user authentication, financial transactions, software license authentication and other computer practices requiring secure information or transmission. Secure data entry is accomplished using a pointing device, such as a mouse or trackball, configured to receive information from a portable data repository, such as a credit card or smart card. Some embodiments of the pointing device include a transducer configured to read the portable data repository, and firmware configured to provide firewall and encryption functions, as well as device identification. Incorporation of these features into a pointing device enables a new, secure, mode of data entry without increasing the number of peripheral devices attached to a computing device.

Various embodiments of the invention include a pointing device comprising a movement detector configured to receive directional input from a user, a multi-bit data sensor including a transducer configured to read data from a portable data repository, a memory configured to store device identification data, and an interface configured to transfer from the pointing device data read from the portable data repository.

Various embodiments of the invention include a pointing device comprising a movement detector configured to receive directional input from a user, memory configured to store data, a logic circuit configured to read and encrypt data stored in the memory, and an interface configured to transfer the encrypted data from the pointing device.

Various embodiments of the invention include a pointing device comprising a movement detector configured to receive directional input from a user, a multi-bit data sensor including a transducer configured to read data from a portable data repository, a memory configured to store data read by the transducer, a Read Only Memory configured to store device identification data, a logic circuit configured to encrypt the data read by the transducer, and an interface configured to transfer, from the pointing device, data read by the transducer.

Various embodiments of the invention include a transaction system comprising a portable data repository having data, and a computing system including a display, a processing unit including memory and computer code, and a pointing device configured to control a cursor shown on the display, the pointing device having (a) a movement detector configured to receive directional input from a user, (b) a multi-bit data sensor including a transducer and configured to read the data from the portable data repository, (c) a logic circuit configured to encrypt the data read from the portable data repository, and (d) an interface configured to transfer the encrypted data from the pointing device to the memory.

Various embodiments of the invention include a method of performing secure transmission of digital data, the method comprising the steps of (a) setting a multi-bit data sensor in a read mode, the multi-bit data sensor being coupled to a pointing device including a logic circuit. (b) reading data from a portable data repository using the multi-bit data sensor. (c) encrypting the read data using the logic circuit, (d) transferring the encrypted data from the pointing device to a processing unit, (e) transferring the digital data and the encrypted data from the processing unit to a third party, and (f) authenticating the digital data transferred from the processing unit using the encrypted data.

Various embodiments of the invention include a method of entering secure data, the method comprising the steps of (a) setting a multi-bit data sensor in a read mode, the multi-bit data sensor being coupled to a pointing device including a logic circuit, (b) disposing a portable data repository relative to the multi-bit data sensor, (c) reading data from the portable data repository using the multi-bit data sensor, (d) encrypting the read data using the logic circuit, and (e) transferring the encrypted data from the pointing device to a processing system.

Various embodiments of the invention include a remote control comprising a mechanical data entry configured to control a video display system, the mechanical data entry including a power control, a volume control, or a channel control, a multi-bit data sensor including a transducer configured to read data from a portable data repository, a memory configured to store the read data, and an interface configured to transfer the read data from the remote control.

Various embodiments of the invention include a transaction system comprising a video display system including a display, a remote control configured to control functions of the video display system, the remote control having, a) a mechanical data entry including a power control, and a volume control or a channel control, b) a multi-bit data sensor including a transducer and configured to read data from a portable data repository, and c) a first interface configured to transfer the read data, from the remote control to other portions of the video display system; and a second interface configured to transfer the read data to a communications network.

Various embodiments of the invention include a method of performing secure transmission of data, the method comprising the steps of setting a multi-bit data sensor in a read mode, the multi-bit data sensor being included in a remote control, the remote control being configured to control a video display system, reading data from a portable data repository using the multi-bit data sensor, transferring, using a wireless interface, the read data from the remote control to the video display system, transferring the read data from the video display system to a third party, and authenticating the read data transferred from the video display system.

Various embodiments of the invention include a method of entering secure data, the method comprising setting a multi-bit data sensor in a read mode, the multi-bit data sensor being included in a remote control having a logic circuit, disposing a portable data repository relative to the multi-bit data sensor, reading data from the portable data repository using the multi-bit data sensor, encrypting the read data using the logic circuit; and transferring the encrypted data from the remote control.

Various embodiments of the invention include a video display system configured for performing a secure transaction, the video display system comprising a remote control including means for controlling functions of the video display system, means for reading data from a portable data repository using the remote control, means for transferring the read data from the remote control to other portions of the video display system, and means for transferring the read data from the video display system to a communications network.

Various embodiments of the invention include a video display system comprising, a) a remote control configured to control functions of the video display system, the remote control having at least a mechanical data entry including a power control, a volume control or a channel control, a first interface configured to transfer data entered by a user from the remote control, and configured to receive data, and memory configured to store the received data, b) a video display configured to display a menu responsive to the data transferred from the remote control, configured for the user to select a number or a letter from the menu, and configured to transfer the selected number or letter from the video display to the remote control through the first interface for storage in the memory, and c) a second interface configured to transfer data stored in the memory from the video display system to a communications network.

### BRIEF DESCRIPTION OF THE VARIOUS VIEWS OF THE DRAWING

FIG. 1 is a block diagram illustrating a computing system according to various embodiments of the invention;

FIG. 2 is a block diagram illustrating embodiments of a pointing device;

FIG. 3A illustrates an embodiment of a portable data repository, including data storage, from which data is read using a multi-bit data sensor;

FIG. 3B illustrates an embodiment of a portable data repository configured as a data card and including data storage in the form of a magnetic strip;

FIG. 3C illustrates an embodiment of a portable data repository configured as a data card including data storage in the form of a barcode and optically readable characters.

FIG. 4 is a block diagram illustrating an embodiment of the invention including the computing system coupled to a remote server through a computer network, such as a local area network or the Internet;

FIGS. 5A and 5B illustrates an embodiment of the invention wherein the pointing device includes a computer mouse;

FIG. 6 illustrates methods according to some embodiments of the invention;

FIG. 7 illustrates a further embodiment of the methods illustrated in FIG. 6; and

FIG. 8 illustrates an embodiment of a pointing device according to various embodiments of the invention.

### DISCLOSURE OF THE INVENTION

The invention includes a pointing device configured to securely read data from a portable data repository such as an identification card or credit card. Optional encryption of the read data enables protected storage and transmission over computer networks. In various embodiments the invention is used to conduct secure transactions and/or generate digital signatures.

For example, in one embodiment, the invention includes a computer mouse having a credit card reader. A credit card number is read using the credit card reader and the resulting data is optionally encrypted before transfer from the mouse to a computer. Encryption on the mouse protects the non-encrypted data from processes running on the computer or elsewhere, and therefore prevents unauthorized access. The encrypted data is communicated from the computer to a merchant or credit card company over the internet. In some embodiments the credit card number read using the credit card reader is compared with a credit card number previously stored on the mouse. An authentication code is given only if these two numbers match. In a further embodiment, the computer mouse also includes device identification data that is encrypted and transmitted along with the credit card number. The features of this embodiment are optionally used to assure that a user of a credit card in an internet transaction is in actual possession of the credit card and that the credit card is being scanned using a previously authorized computer mouse.

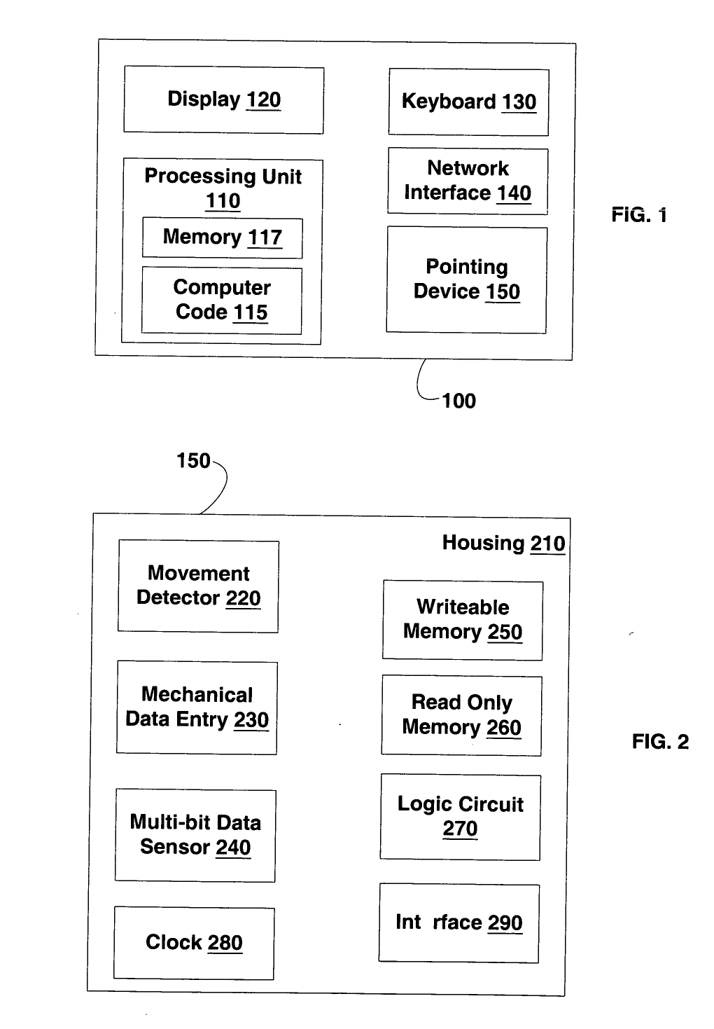

FIG. 1 is a block diagram illustrating a Computing System 100 according to various embodiments of the invention. In some embodiments, Computing System 100 includes a Processing Unit 110 having memory 117 and configured to execute computer code 115. In these embodiments, Computing System 100 may be, for example, a personal computer, personal digital assistant, or similar computing device. Interaction between a user and Processing Unit 110 is facilitated by a display 120 and a keyboard 130. Display 120 optionally supports a graphical user interface such as that displayed to a user using Microsoft Windows®. Computing System 100 also includes a Pointing Device 150 and a Network Interface 140. Pointing Device 150 is a device configured for a user to control a cursor or to point to specific elements shown on Display 120. For example, in various embodiments Pointing Device 150 is a computer mouse, trackball, joystick, stylus, or the like. Network Interface 140 is configured for communication between Computing System 100 and a computer network such as the internet. In a typical embodiment, Pointing Device 150 is used to navigate through the World Wide Web using a browser displayed on Display 120. Computer Code 115 typically includes the browser displayed on Display 120 and drivers configured to support Pointing Device 150 and Network Interface 140. In some embodiments Computer Code 115 also includes encryption/decryption procedures (e.g., algorithms) configured to process data received from Pointing Device 150 or through the browser. In some embodiments parts of encryption/decryption algorithms are executed by both Computer Code 115 and on Pointing Device 150.

In alternative embodiments, Computing System 100 is a video display system such as a television, digital video monitor, video playback system, video recorder, video receiver, video tuner, computer with video tuner, video game console with video tuner, or the like. In these embodiments Network Interface 140 includes a video input interface configured to receive a video signal. For example, in one embodiment Computing System 100 is a television display combined with an interactive video receiver. The interactive video receiver receives a video signal through Network Interface 140 and uses this signal to display a video on the television. The interactive video receiver is configured to receive input from a remote control, such as a wireless remote, and to pass this input through Network Interface 140 to a communications network, such as a computer network, cable network, satellite network, telephone network, or the like. In these embodiments Keyboard 130 and Processing Unit 110 are optional. In embodiments wherein Computing System 100 is a video display system Pointing Device 150 is typically a remote control configured to control operation of Computing System 100.

FIG. 2 is a block diagram illustrating embodiments of Pointing Device 150. Pointing Device 150 typically includes a Housing 210 configured to connect other portions of Pointing Device 150. These portions include Movement Detector 220 and Mechanical Data Entry 230. Movement Detector 220 is configured to receive directional input from a user by detecting movement of Pointing Device 150 and/or other movement made by a user to control a cursor or point to an object shown on Display 120. For example, in various embodiments Movement Detector 220 is an optical sensor on an optical mouse, the ball of a track ball or a mechanical mouse, the handle of a joystick, or the like. In one embodiment, Pointing Device 150 is a stylus and Movement Detector 220 is a device used to determine the location of a tip of the stylus. Optional Mechanical Data Entry 230 typically includes buttons, wheels or other data entry means capable of determining simple (single bit) data values.

Pointing Device 150 includes a Multi-bit Data Sensor 240 configured to receive multi-bit data from a portable data repository. In various embodiments Multi-bit Data Sensor 240 is configured to receive electronic, electromagnetic, optical, or other analog or digital data. For example, in one embodiment Multi-bit Data Sensor 240 is configured to detect electrical properties (e.g., voltage, resistance, current) of the portable data repository. In other embodiments, Multi-bit Data Sensor 240 includes a transducer configured to detected an electromagnetic signal (e.g., wireless signal) or a magnetic field (e.g., the field of a magnetic strip or tape). The transducer may also be configured to detect optical signals from an optical storage device, optical memory, barcode, text or the like. In an exemplary embodiment Multi-bit Data Sensor 240 includes a transducer designed to read a barcode or magnetic strip attached to a data card. In another exemplary embodiment Multi-bit Data Sensor 240 includes a transducer configured for optical character recognition. The data card being a credit card, debit card, phone card, smart card, identification card (e.g., driver's license), or the like. Data generated by the transducer is optionally digitized to generate multiple-bit digital data. In some embodiments Multi-bit Data Sensor 240 is configured to write data to as well as read data from a portable data repository.

Pointing Device 150 includes optional memory, such as Writeable memory 250 and Read Only Memory 260. Optional Writeable Memory 250 is typically random access memory configured to store data received from Multi-bit Data Sensor 240. Some embodiments of Pointing Device 150 are configured such that only data received from Multi-bit Data Sensor 240 may be written to Writeable Memory 250 or some portion thereof. However, in some embodiments Writeable Memory 250 may include memory used to store data received by Pointing Device 150 from Processing Unit 110 (FIG. 1) or computer instructions used to process data stored in Writeable Memory 250 or Read Only Memory 260.

Optional Read Only Memory 260 is static memory configured to store digital data. In various embodiments this digital data may include data uniquely identifying Pointing Device 150, data card (i.e. credit card) identifying data, user identifying data, password data, encryption/decryption keys, or the like. For example, in one embodiment Read Only Memory 260 includes a fixed password and a knowledge of this password is required to modify portions of Writeable Memory 250. In another example, Read Only Memory 260 includes a device identification data (e.g., serial number) of Pointing Device 150. This serial number is optionally used to uniquely identify Pointing Device 150. In one embodiment Read Only Memory 260 is detachable from Pointing Device 150.

Pointing Device 150 optionally includes a Logic Circuit 270 configured to manage data operations. In some embodiments, Logic Circuit 270 acts as a data gateway, limiting data that can be written to Writeable memory 250 and processing data read from Writeable memory 250 or Read Only Memory 260. In some embodiments, portions of Read Only Memory 260 and/or portions of Writeable Memory 250 may be read only by Logic Circuit 270. In some embodiments, Logic Circuit 270 includes circuitry and/or program instructions for decryption, encryption, or data comparison. For example, in some embodiments Logic Circuit 270 is configured to encrypt data received from Multi-bit Data Sensor 240. In some of these embodiments, data received from Multi-bit Data Sensor 240 is encrypted before being stored in any memory location accessible to processes external to Pointing Device 150. Thus, it can be made impossible for a process on computing system 100 to access data received from Multi-bit Data Sensor 240 prior to encryption. In another example, embodiments of Logic Circuit 270 includes circuitry and/or program instructions configured to encrypt data stored in Read Only Memory 260. In some of these embodiments data identifying Pointing Device 150 is first read from Read Only Memory 260. The read data is encrypted in Logic Circuit 270 and then included in a digital signature.

The encryption processes performed by Logic Circuit 270 may be one of the many symmetric or non-symmetric, public or private key encryption schemes known in the art, such as private/public key encryption, hash functions, PGP (pretty good privacy), RSA (Rivest, Shamir, Adleman), DES (Data Encryption Standard), Diffie-Hellman, RC5, ESIGN (Electronic Signatures in Global and National Commerce Act) signatures, Fiat-Shamir identification, Schonrr signatures, GQ (Guillou-Quisquater) identification, IDEA (International Data Encryption Algorithm) cipher, FEAL (Fast Data Encipherment Algorithm), MDC Hashing, SHA-1 (Secure Hash Algorithm), CBC-MAC (Cipher Block Chaining Message Authentication Code), DSA (Digital Signature Algorithm) and the like. The encryption processes are also optionally multi-step. For example, in one embodiment data received from Multi-bit Data Sensor 240 is first encrypted. This data is then combined with a pointing device serial number stored in Read Only Memory 250 and encrypted again. In some embodiments data received from Multi-bit Data Sensor 240 is encrypted in distinct segments. For example, in embodiments wherein data received from Multi-bit Data Sensor 240 is credit card information, the card holder name, expiration date, and last four digits of the credit card number may be encrypted such that both a merchant and the credit card company can decrypt the data, while the remainder of the information read from the card is encrypted in a manner such that only the credit card company can decrypt. In some embodiments, the encryption processes performed by Logic Circuit 270 includes conversion of the data being encrypted into an encrypted digital signature. This encrypted data (e.g., digital signature) is optionally used to authenticate digital data transferred to a third party.

Several encryption algorithms require the generation of pseudorandom numbers. These numbers are optionally generated within Pointing Device 150 in a region of Writeable Memory 260 isolated from external processes. In some embodiments pseudorandom numbers are generated using a crystal oscillator based counting device and/or clock located within Housing 210. This approach is analogous to the use of a crystal based clock for pseudorandom number generation. In some embodiments bit streams from movement detection 220 and/or mechanical data entry 230 are used in generating pseudorandom numbers. In some embodiments pseudorandom numbers are generated using a random seed number selected prior to delivery of Pointing Device 150 to an end user.

Pointing Device 150 optionally includes a Clock 280 configured to facilitate time dependent operation of Logic Circuit 270, Writeable Memory 230 or Read Only Memory 260. For example, in some embodiments data received through Multi-bit Data Sensor 240 is made available to Processing Unit 110 for a limited time period. Clock 280 is used to determine when this limited period is completed. In one embodiment, data is read from a credit card and/or smart card using Multi-bit Data Sensor 240 and written to Writeable Memory 250. Using Clock 280, this data is available for only a one minute period. In another example, data is read from an authorization card (e.g., key card) used to authenticate a software license. This data is available to processes outside of Pointing Device 150 for a limited period, such as one hour. Some embodiments of the invention include software whose use is limited by availability of this data, such that some functionality of the software is only available during the limited period.

In some embodiments data is read from a smart card using Multi-bit Data Sensor 240. This data may include, for example, a user address or password programmed into the smart card by a user or third party. In one embodiment, Clock 280 is used to limit access to the data, read from the smart card, to a limited period. This ability allows the user to remove the smart card from Pointing Device 150 while maintaining temporary availability of data stored therein to Logic Circuit 270 and/or processes external to Pointing Device 150.

In some embodiments data read from a smart card using Multi-bit Data Sensor 240 is used to transfer functionality from the smart card to Pointing Device 150. In these embodiments the transferred data is used to enable processes that the smart card is configured to perform, such as calculation of account balances, encryption, data logging, or the like, on Pointing Device 150. For example, in one embodiment, the smart card is momentarily inserted in Pointing Device 150. During this insertion data is transferred from the smart card to the Pointing Device 150 such that Pointing Device 150 is able to perform a specific encryption process for which the smart card is configured. In another embodiment, the smart card is momentarily inserted in Pointing Device 150 and a data logging process is initiated on Pointing Device 150. In this embodiment a second insertion of the smart card into Pointing Device 150 is optionally used to transfer results of the logging operation from Pointing Device 150 to the smart card.

Pointing Device 150 additionally includes an Interface 290 configured to communicate with external components, such as other components of Computing System 100. In typical embodiments Interface 290 enables one or two-way communication between Processing Unit 110 and Pointing Device 150. Interface 290 may be electronic, optical and/or wireless and is typically configured to also transfer directional input generated by Movement Detector 220, device identification data, data read using Multi-bit Data Sensor 250, or the like.

In embodiments wherein Computing System 100 is a video display system, Pointing Device 150 is typically a remote control such as an infrared remote, radio frequency remote, a wired remote, or the like. In these embodiments, Movement Detector 220, Writeable Memory 250, Logic Circuit 270, and Clock 280 are optional. Mechanical Data Entry 230 includes controls configured to control functions of Computing System 100. In one embodiment Mechanical Data Entry 230 includes an input to turn Computing System 100 on or off, an input to control volume, and/or an input to change a video channel. Interface 290 is typically a radio frequency, infrared, or other electronic or photonic output configured for sending data to other portions of Computing System 100. Interface 290 is optionally a one way communications channel.

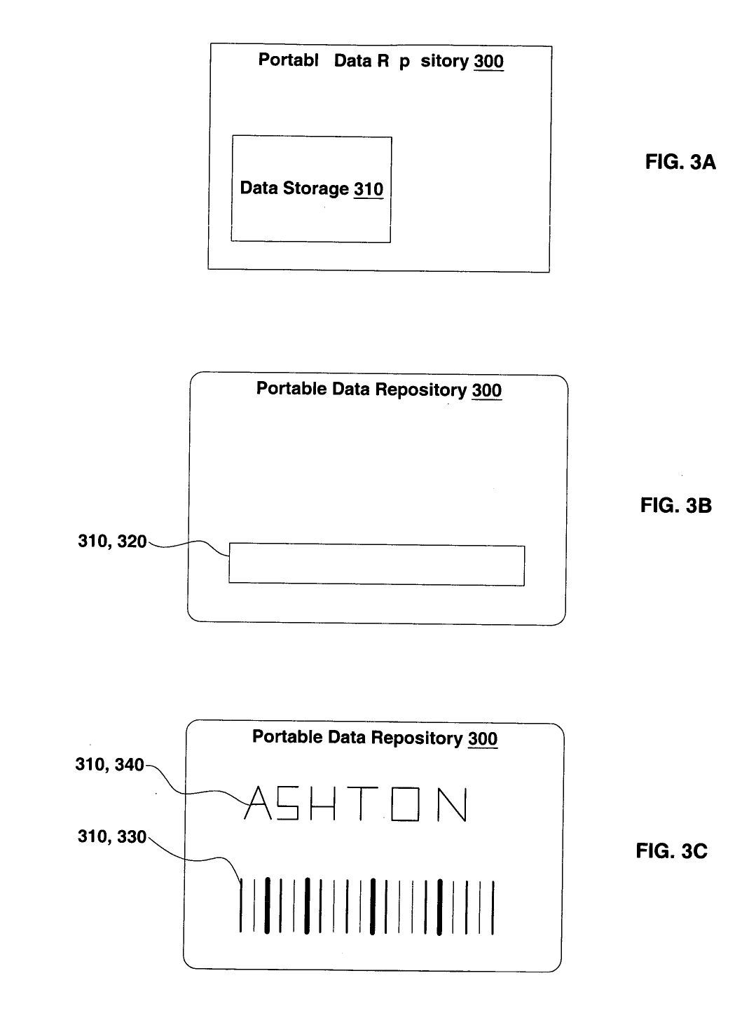

FIG. 3A illustrates a Portable Data Repository 300, including Data Storage 310, from which data is read using Multi-bit Data Sensor 250. Portable Data Repository 300 communicates with Multi-bit Data Sensor 250 through electronic, optical, wireless, electromagnetic or like means. For example, in some embodiments Portable Data Repository 300 includes ROM and electrical contacts configured to couple with Multi-bit Data Sensor 250. In some embodiments Portable Data Repository 300 includes a wireless transponder configured to transmit data to Multi-bit Data Sensor 250. In these embodiments Multi-bit Data Sensor 240 includes a wireless transducer configured to generate electronic data responsive to the transmitted data. In some embodiments Portable Data Repository 300 includes a data card such as a smart card, credit card, debit card, phone card, identity card or the like. For example, FIG. 3B illustrates a Portable Data Repository 300 configured as a data card and including Data Storage 310 in the form of a Magnetic Strip 320. Embodiments of this configuration include credit cards, debit cards and identity cards, among others. In these embodiments Multi-bit Data Sensor 250 is configured to read data from Magnetic Strip 320 using an electromagnet transducer. FIG. 3C illustrates an alternative embodiment wherein Portable Data Repository 300 is configured as a data card including Data Storage 310 in the form of a Barcode 330 and optically readable characters 340. In this embodiment Multi-bit Data Sensor 250 includes an optical transducer and/or an optional light source, configured to detect optical signals and generate resulting electronic data.

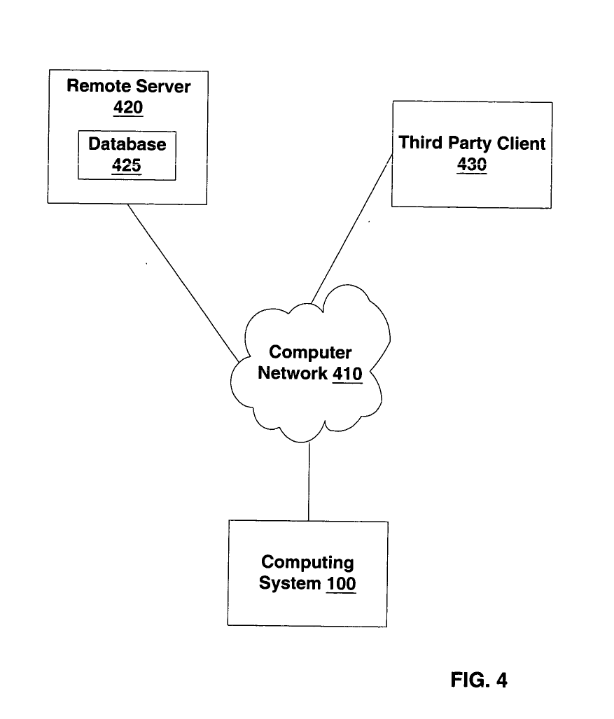

FIG. 4 is a block diagram illustrating an embodiment of the invention including Computing System 100 coupled to a Remote Server 420 through a Computer Network 410, such as a local area network or the Internet. Remote Server 420 is configured to receive and optionally decrypt data generated using Pointing Device 150 and Portable Data Repository 300. In some embodiments, Remote Server 420 decrypts this data to determine data authenticity. For example, when the data includes encrypted credit card information or a digital signature, Remote Server 420 may be controlled by a credit card company and be configured to decrypt the data to confirm the authenticity of the information and to send a confirmation, denial or approval to a Third Party Client 430. Third Party Client 430 may, for example, be a merchant involved in an electronic transaction with a user of computing system 100.

Remote Server 420 optionally includes a Database 425 configured to store credit card information, encryption or decryption keys, passwords, transaction records, serial numbers identifying Pointing Devices 150, or the like. For example, in some embodiments Database 425 includes credit card numbers, billing addresses and account holder names. In some embodiments Database 425 includes data records associating a credit card with data, such as a serial number, identifying Pointing Device 150.

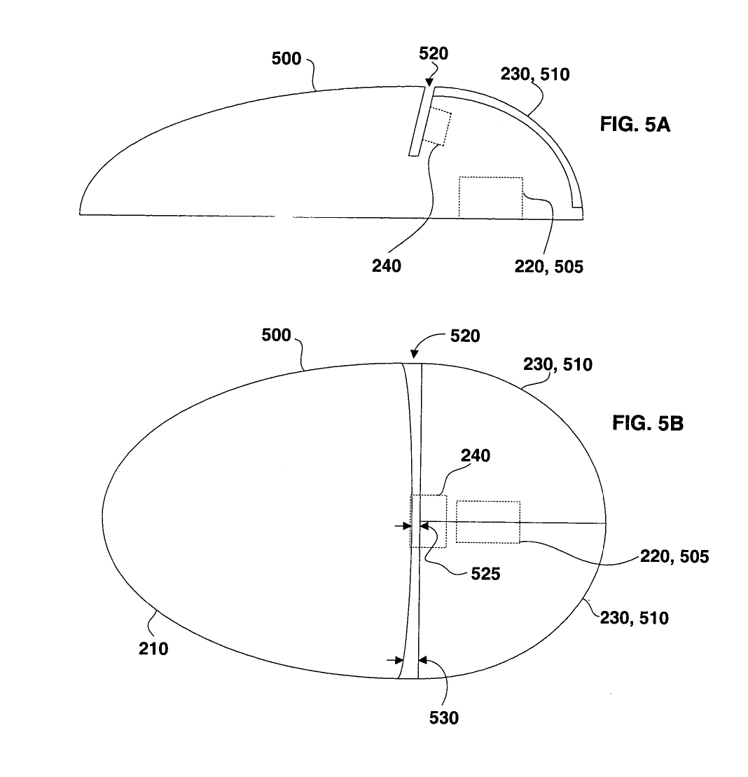

FIG. 5 illustrates an embodiment of the invention wherein Pointing Device 150 includes a Computer Mouse 500. In the illustrated embodiment, Movement Detector 220 and Mechanical Data Entry 230 are embodied by Movement Sensor 505 and Buttons 510 of Computer Mouse 500, respectively. Movement Sensor 505 optionally includes a rolling ball, optical detector, or other known means of determining computer mouse movement. Computer Mouse 500 also includes a slot, generally designated 520, configured to receive a Portable Data Repository 300 such as a data card. An embodiment of Multi-bit Data Sensor 240 is disposed adjacent to Slot 520 such that data is read from a data card swiped through Slot 520. A First Slot Width 525 is optionally configured such that a data card is appropriately positioned relative to Multi-bit Data Sensor 240 to facilitate the data transfer. A Second Slot Width 530 is optionally configured to facilitate insertion of a data card into Slot 520. Second Slot Width 530 is typically wider than First Slot Width 525. Slot 520 may also be disposed longitudinally along the top of Computer Mouse 500, in a direction perpendicular to that shown in FIG. 5. In alternative embodiments Slot 520 is disposed along a front, side, back or bottom of Computer Mouse 500 or on an alternative Pointing Device 150 such as a joystick or trackball.

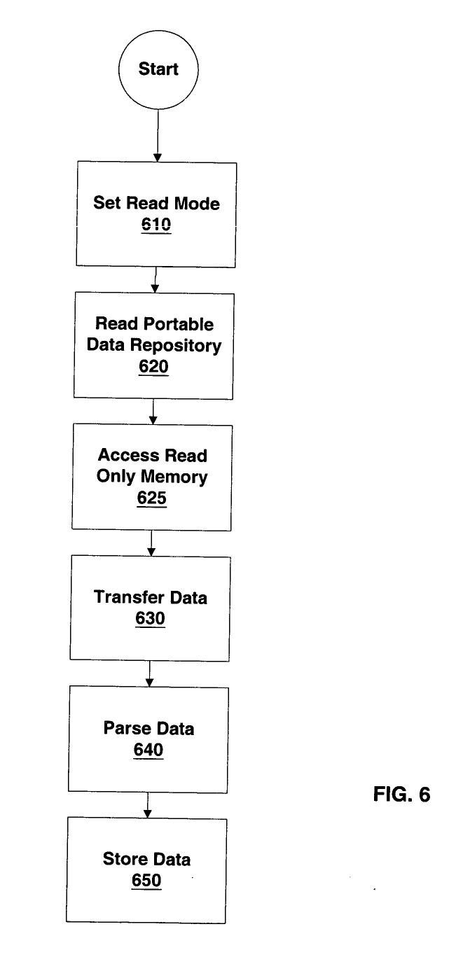

FIG. 6 illustrates methods according to some embodiments of the invention. In a Set Read Mode Step 610 Pointing Device 150 is placed in a “read” state wherein it is configured to receive data from Portable Data Repository 300. For example, in various embodiments of the read state Pointing device 150 is configured to receive an electronic, wireless, electromagnetic or optical signal. In one embodiment, the read state includes activation of a light source configured for reading a barcode or optical character recognition. In another embodiment, the read state includes activation of a query signal configured for receipt by a wireless transponder. The read state may be a default state established prior to delivery of Pointing Device 150 to a user or, in some embodiments, placement of Pointing Device 150 in the read state optionally requires a user password.

In a Read Portable Data Repository Step 620 data is transferred, using means discussed herein, from Portable Data Repository 300 to Pointing Device 150. This transfer optionally includes disposing Portable Data Repository 300 relative to Pointing Device 150 and using a transducer configured to convert data from a non-electronic medium to electronic data. For example, in some embodiments Read Portable Data Repository Step 620 includes swiping a Portable Data Repository 300 (e.g., data card) having a magnetic strip 320 (FIG. 3A) through Slot 520 (FIG. 5).

In an optional Access Read Only Memory Step 625 data is read from Read Only Memory 260. This data is typically used to identify Pointing Device 150 or a user. For example, in one embodiment data read in Access Read Only Memory Step 625 is a pointing device identification data. This data is optionally associated with a list of credit cards authorized to perform secure transactions using a particular Pointing Device 150. In another example, data read in Access Read Only Memory Step 625 includes a user name, address, account number, credit card number, or other user data, and only credit cards matching this data are authorized to perform secure transactions using the particular Pointing Device 150.

Data read from Portable Data Repository 300 in Read Portable Data Repository Step 620 is optionally stored in Writeable Memory 250 (FIG. 2). This data may include any of the information stored in Portable Data Repository 300. In alternative embodiments data read from Portable Data Repository 300 is maintained in an analog form until after completion of a Transfer Data Step 630.

Transfer Data Step 630 includes delivery of the read data from Pointing Device 150 to Memory 117 (FIG. 1). This transfer may occur through the same means by which data entered using Mechanical Data Entry 230 or data generated by Movement Detector 220 is transferred to Memory 117. For example, in various embodiments data is transferred through a wireless, serial port, parallel port, or USB connection. In alternative embodiments data is transferred in an analog form and/or using a custom protocol.

Upon receipt of data at Processing Unit 110, Computer Code 115 is used to perform a Parse Data Step 640. In this step data received from Pointing Device 150 is parsed to distinguish data generated using Movement Detector 220 or Mechanical Data Entry 230 from data generated through Read Portable Data Repository Step 620 and/or from data retrieved from Read Only Memory 260. In some embodiments Computer Code 115 includes a device driver configured to receive data from Pointing Device 150 and process data from each of the above sources.

In a Store Data Step 650 data identified in Parse Data Step 640 as not being generated using Movement Detector 220 or Mechanical Data Entry 230 is saved in Memory 117. The saved data is optionally made available to other programs such as browsers, encryption/decryption routines, security protocols, digital signature generators, license authentication routines, communication software, or the like. For example, in some embodiments the data is accessed by an internet browser or other communication software and delivered to an external system, such as Remote Server 420 or Third Party Client 430 (FIG. 4). In some embodiments the data is used as a key by encryption or decryption routines. In some embodiments the data is further processed by encryption or decryption routines. In some embodiments the data is used by security protocols to establish user permissions, confirm access rights, confirm a software license or the like. For example, the data is optionally used to identify a party in an online auction, log into an online e-mail account, access an online service or file, or the like. In some embodiments the data is used to generate a digital signature. In some embodiments the data is used to trace a stolen credit card, debit card, smart card or the like.

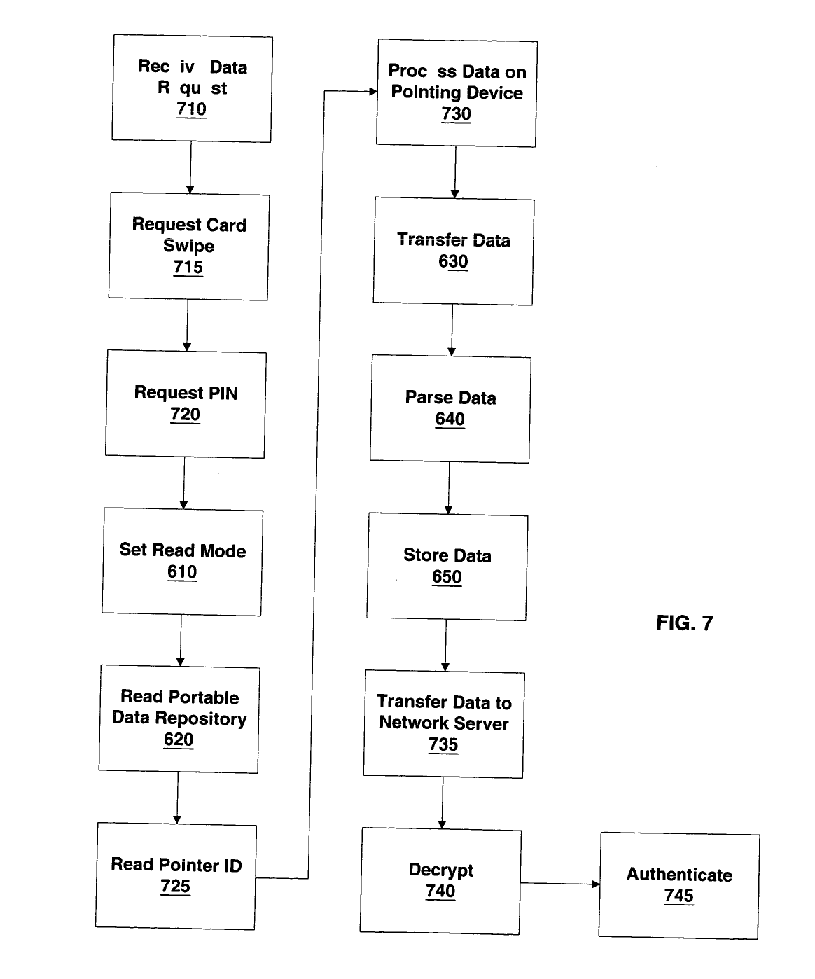

FIG. 7 illustrates a further embodiment of the method illustrated in FIG. 6. This embodiment is exemplary of several additional, optional, steps. In an optional Receive Data Request Step 710 a request is received, at Computing System 100, from an external source such as Remote Server 420 or Third Party Client 430. This request may be, for example, a request from an Internet based merchant for credit card payment. In an optional Request Card Swipe Step 715, Computer Code 115 is used to display a message to a user of Computing System 100 indicating that use of Multi-bit Data Entry 240 or access to Read Only Memory 260 is requested. A user may accept or decline this request, thus controlling access, by third parties or independent processes, to Writeable Memory 250 and/or Read only Memory 260. In some embodiments a Request PIN Step 720 is used to solicit a personal identification number or other password from a user. This information may act as further security and is optionally written to Writeable Memory 250 where it may be accessed by Logic Circuit 270 and/or compared with data from Read Only Memory 260. In some embodiments the information received in Request PIN Step 720 is used to authorize execution of Set Read Mode Step 610 or Access Read Only Memory Step 625. Information received in Request PIN Step 720 may be used in addition to data read from Read Only Memory 260. Steps 610 and 620 are performed as discussed in relation to FIG. 6.

An optional Read Pointer ID Step 725 is used to retrieve data stored in Read Only Memory 260. This data may include information identifying Pointing Device 150 (e.g., a serial number of Pointing Device 150), user data, encryption or decryption keys, or other data stored in Read Only Memory 260. The read data is optionally subsequently stored in Writeable Memory 250.

In an optional Process Data On Pointing Device Step 730 data stored in Writeable Memory 250 or read from Read Only Memory 260 is processed using Logic Circuit 270. Processing may include encryption/decryption, comparison, truncation or the like. In some embodiments data generated in Read Portable Data Repository Step 620 and Read Pointer ID Step are encrypted together. In some embodiments data received in Request PIN Step 720 is also encrypted. Following Process Data On Pointing Device Step 730, encrypted and/or non-encrypted data are processed using steps 630, 640 and 650 as describe with respect to FIG. 6.

In an optional Transfer Data to Network Server Step 735 data, received from Pointing Device 150 in Transfer Data Step 630, is delivered through Computer Network 410 to Remote Server 420 or Third Party Client 430. This transfer is typically made using standard protocols such as HTTP or FITP.

In an optional Decrypt Step 740 data received by Remote Server 420 or Third Party Client 430 in Transfer Data to Network Server Step 735 is decrypted. The decrypted data is optionally used for authentication of user identity, pointing device identity, credit card data, or other information in an optional Authenticate Step 745. Decryption and authentication are performed using computer instructions, not shown, included in embodiments of the invention.

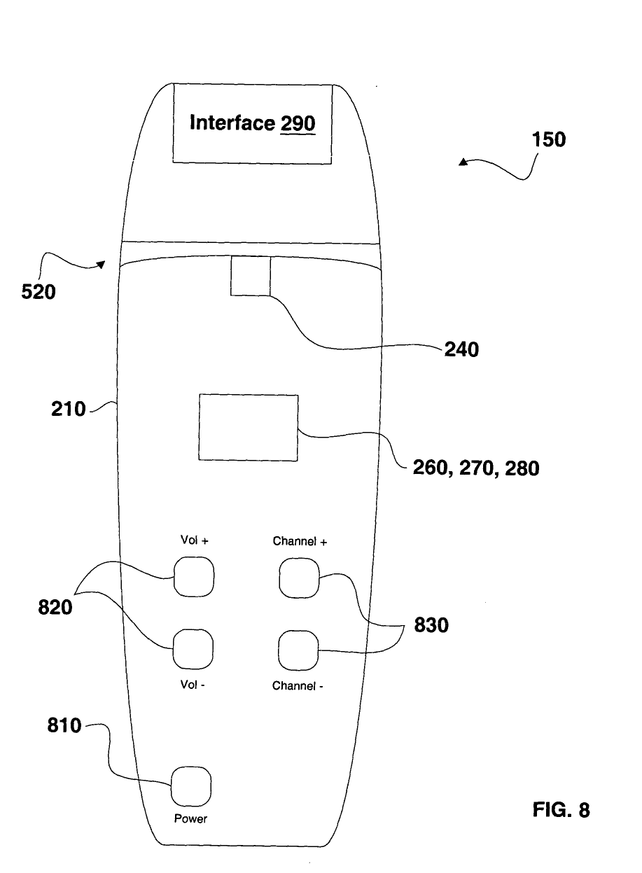

FIG. 8 illustrates an embodiment of Pointing Device 150 according to various embodiments of the invention. In this embodiment, Computing System 100 is a video display system and Pointing Device 150 is a remote control having a Housing 210. Interface 290 is a wireless remote interface and Mechanical Data Entry 230 optionally includes a Power Button 810, Volume Control Buttons 820, and/or Channel Selection Buttons 830. In the embodiment illustrated in FIG. 8, Slot 520 is shown extending across one dimension of Pointing Device 150. In alternative embodiments, Slot 520 is located in other positions such as across a different dimension of Pointing Device 150, at either end of Pointing Device 150, along a side of Pointing Device 150, or the like. Multi-bit Data Sensor 240 is positioned adjacent to Slot 520. The illustrated embodiment of Pointing Device 150 also includes optional Read Only Memory 260, Logic Circuit 270 and/or Clock 280. Read Only Memory 260 is configured to store device identification data, such as a serial number, account number, user identification number, or the like. Logic Circuit 270 is optionally configured to encrypt data stored in Read Only Memory 260 or data read using Multi-bit Data Sensor 240. Clock 280 is optionally used to generate pseudorandom numbers for use by Logic Circuit 270. In various embodiments, Pointing Device 150 includes both an x-y pointer, such as a trackball and is configured as a remote control for a video display system.

In some embodiments Pointing Device 150 is configured to be programmed using Display 120. For example, when Pointing Device 150 is a remote control it may be desirable to program a serial number, credit card number, user name, billing address or other data into Pointing Device 150. In these embodiments, buttons of Pointing Device 150 are used to enter data. Information responsive to this data is transmitted from Pointing Device 150 to Display 120 wherein menus, programming status, entered data, or the like is displayed to the user. In one embodiment, a user name is programmed into Pointing Device 150 by displaying an alphabet on Display 120. The user uses controls included in Pointing Device 150 to navigate the alphabet and spell out the user name. During the programming process Display 120 shows the status of the programming process. When the programming process is complete the user name is stored in Pointing Device 150. Other alphanumeric data is optionally programmed into Pointing Device 150 in a similar manner. In these embodiments, Multi-bit Data Sensor 240 is optional.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and though which these teachings have advanced the art, are considered to be within the spirit and scope of the present invention. Hence, these descriptions and drawings should not be considered in a limiting sense, as it is understood that the present invention is in no way limited to only the embodiment illustrated.

Microsoft Windows® is a registered trademark of Microsoft Corporation.

I claim:

1. A remote control comprising:
a mechanical data entry configured to control a video display system, the mechanical data entry including a power control, a volume control, or a channel control;
a multi-bit data sensor including a transducer configured to read data from a portable data repository;
a memory configured to store the read data and information identifying the remote control; and
an interface configured to transfer the read data and the identifying information from the remote control.

2. The remote control of claim 1, wherein the transducer is an electromagnetic transducer.

3. The remote control of claim 1, wherein the transducer is an optical transducer.

4. The remote control of claim 1, wherein the interface is a wireless interface.

5. The remote control of claim 1, further including a video display configured for programming the remote control.

6. The remote control of claim 1, further comprising a logic circuit configured to encrypt the read data.

7. The remote control of claim 6, wherein the logic circuit is further configured to encrypt device identification data.

8. The remote control of claim 7, wherein the data read from the portable data repository is an account number.

9. The remote control of claim 7, wherein the data read from the portable data repository is a credit card number.

10. The remote control of claim 7, wherein the data read from the portable data repository is user identifying data.

11. The remote control of claim 6, further including means for generating a pseudorandom number for use by the logic circuit.

12. The remote control of claim 1, further including an x-y pointer.

13. The remote control of claim 1, further including a trackball configured as an x-y pointer.

14. A transaction system comprising:
a video display system including,
a display,
a remote control configured to control functions of the video display system, the remote control having
a) a mechanical data entry including a power control, and a volume control or a channel control,
b) a multi-bit data sensor including a transducer and configured to read data from a portable data repository, and
c) a first interface configured to transfer the read data, from the remote control to other portions of the video display system;
memory configured to store device identification data; and
a second interface configured to transfer the read data to a communications network.

15. The transaction system of claim 14, further including the portable data repository.

16. The transaction system of claim 15, wherein the remote control further includes a logic circuit configured to encrypt the data read from the portable data repository.

17. The transaction system of claim 14, further including a network server configured to receive and decrypt the data transferred to the communications network.

18. The transaction system of claim 14, wherein the display is configured for use in programming the remote control.

19. The transaction system of claim 14, wherein the remote control is configured to transmit programming instructions to the display.

20. A method of performing secure transmission of data, the method comprising the steps of:
setting a multi-bit data sensor in a read mode, the multi-bit data sensor being included in a remote control, the remote control being configured to control a video display system;
reading data from a portable data repository using the multi-bit data sensor;
transferring, using a wireless interface, the read data from the remote control to the video display system;
transferring the read data from the video display system to a third party; and
authenticating the read data transferred from the video display system.

21. The method of claim 20, further including encrypting the read data using a logic circuit.

22. The method of claim 21, wherein the logic circuit is included in the remote control.

23. The method of claim 20, further including transferring device identification data from the remote control to the third party.

24. The method of claim 23, wherein the device identification data is configured to identify the remote control.

25. The method of claim 23, further including a step of determining, using the device identification data, a credit card authorized to perform secure transactions.

26. The method of claim 20, further including a step of generating a pseudorandom number using the remote control.

27. The method of claim 26, further including using the pseudorandom number to encrypt the read data using a logic circuit.

28. A method of entering secure data, the method comprising:
setting a multi-bit data sensor in a read mode, the multi-bit data sensor being included in a remote control having a logic circuit;
disposing a portable data repository relative to the multi-bit data sensor;
reading data from the portable data repository using the multi-bit data sensor;
encrypting the read data using the logic circuit; and
transferring the encrypted data from the remote control.

29. The method of claim 28, wherein the portable data repository is a credit card, debit card, smart card, or identification card.

30. A video display system configured for performing a secure transaction, the video
display system comprising:
a remote control including means for controlling functions of the video display system;
means for reading data from a portable data repository using the remote control;
means for transferring the read data from the remote control to other portions of the video display system; and
means for transferring the read data from the video display system to a communications network.

31. The secure transaction system of claim 30, further including means for encrypting the read data.

32. The secure transaction system of claim 30, further including means for encrypting the
a remote control configured to control functions of the video display system, the remote control having at least
a mechanical data entry including a power control, a volume control or a channel control,
a first interface configured to transfer data entered by a user from the remote control, and configured to receive data, and
memory configured to store the received data;
a video display configured to display a menu responsive to the data transferred from the remote control, configured for the user to select a number or a letter from the menu, and configured to transfer the selected number or letter from the video display to the remote control through the first interface for storage in the memory; and
a second interface configured to transfer data stored in the memory from the video display system to a communications network.

33. The video display system of claim 32, further including memory configured to store device identification data.

34. The video display system of claim 33, wherein the memory configured to store device identification data is included in the video display.

35. The video display system of claim 33, wherein the memory configured to store device identification data is included in the remote control.

36. The video display system of claim 32, wherein the data stored in the memory includes credit card data.

37. The video display system of claim 32, wherein the data stored in the memory includes address data.

38. The video display system of claim 32, further including a multi-bit data sensor configured to read data from a data repository for storage in the memory.
